(19) United States
(12) Patent Application Publication
(10) Pub. No.: US 2008/0272047 A1
(43) Pub. Date: Nov. 6, 2008

(54) Separating Device

(75) Inventors: Per Mellegard, Skovde (SE); Stefan Naij, Asa (SE)

Correspondence Address: HARNESS, DICKEY & PIERCE, P.L.C., P.O. BOX 8910, RESTON, VA, 20195, US

(73) Assignee: MELLEGARD & NAIJ AB, Skovde (SE)

(21) Appl. No.: 10/585,951

(22) PCT Filed: Jan. 20, 2005
(86) PCT No.: PCT/SE2005/000058

§ 371 Date: Jul. 7, 2008

(30) Foreign Application Priority Data
Jan. 26, 2004 (SE) 0400143-4

(51) Int. Cl. B03B 5/28; B01D 21/28

(52) U.S. Cl. 210/384; 209/162

(57) ABSTRACT

The invention relates to a grit washer for separating organic pollutants from grit in wastewater treatment plants, said device comprising a container (2) which has a material supply inlet (5), a grit outlet (7), a separating water inlet (6) and a liquid discharging means (10). The container (2) has a vibrating means (8) arranged inside the container (2) in order to separate, while vibrating in cooperation with the supplied separating water, the grit from organic matter. The invention also relates to a device for separating solid matter in flowing liquids in wastewater treatment plants, the device comprising a screening unit (30) which is arrangeable in a duct with flowing liquid, the screening unit (30) having movably arranged discharging means (39) which feed the solid matter up to an unloading portion (35) having a vibrating means (46) which releases the solid matter from the unloading portion (35). The invention also relates to a screw-type washing press for separating faeces from solid objects and compressing these objects, the device having at least one vibrating means (75; 75′) for improving the separation of the faeces from the solid matter. The invention also relates to a vibrating means (8; 46; 75; 75′) arranged in a device as stated above.

### TECHNICAL FIELD

The present invention relates, according to a first aspect, to a device for separating mainly organic matter from mainly inorganic matter, especially organic pollutants from grit in wastewater treatment plants, said device comprising a container which is adapted to receive organic matter, inorganic matter and liquid, said container having at least a first inlet for supplying organic and inorganic matter to said container, at least one outlet arranged adjacent to said container for discharging inorganic matter from said container, at least a second inlet for supplying separating water, and at least one connectable means for discharging organic matter and liquid from said container.

The invention also relates, according to a second aspect, to a device for separating mainly organic matter and solid matter from a flowing liquid, especially for collecting and discharging solid particles and objects in flowing liquids in wastewater treatment plants, the device comprising an elongate screening unit with a lower part which is arrangeable in a duct with flowing liquid, said screening unit being provided with at least one set of movably arranged collecting and discharging means, said collecting and discharging means being operable by a drive unit for moving said mainly organic matter and said solid matter up from said flowing liquid to be fed upwards along said elongate screening unit to an unloading portion.

Moreover, the invention concerns, according to a third aspect, a device for separating mainly organic disintegratable matter from solid matter, especially separating in wastewater treatment plants mainly faeces from solid objects and compressing said objects, said device having a screw trough with a rotatably arranged screw means, a receiving portion for receiving said mainly organic disintegratable matter and said solid matter, a washing portion with liquid supply for separating said mainly organic disintegratable matter from said solid matter, a compressing portion, said compressing portion being surrounded at least partially by a perforated housing, and a discharge portion for compressed matter, said screw means essentially extending from said receiving portion to said discharge portion, said screw means feeding said organic disintegratable matter and said solid matter from said receiving portion to said washing portion for supply of liquid and separation, the liquid being pressed by said screw means through said perforated housing adjacent to said compressing portion, the screw means discharging said compressed matter adjacent to the discharge portion.

### BACKGROUND ART

Wastewater treatment plants of the above type are well known. Such wastewater treatment plants are used to separate, in various ways, liquid, organic and/or inorganic matter. This is carried out to provide a more homogeneous material from the wastewater treatment plant.

In connection with the device, according to the first aspect, for separating inorganic matter, such as grit from organic pollutants and liquid, a grit washer is commonly used. The grit washer has in operation usually a bed of grit at the bottom of a container. The incoming material is supplied to the bed of grit. The incoming material comprises, for example, grit, gravel, stones, light particles, organic pollutants and liquids, such as water.

A supplementary supply of water usually occurs to the bed of grit so that lighter particles, such as organic pollutants, are moved up through the grit by means of the water. To increase this effect, a blade-shaped agitator can be rotatably arranged in the container to agitate the material in the container. Excess water is discharged through an outlet in the upper part of the container. Also the organic matter is removed through an outlet in the upper part of the container. On completion of a purification cycle, some of the washed bed of grit at the bottom of the container is removed by a grit screw. The removed grit has thus by means of the wastewater treatment plant reduced its content of organic matter.

The drawbacks of this type of wastewater treatment plant are one or more of the following:
the organic pollutants are not sufficiently released from the grit;
parts of the incoming material stick to the blade agitator;
parts of the incoming material, such as organic matter, stick to the inside of the container;
the supplied water has difficulty in separating the organic matter from the grit and the bed of grit. This problem normally increases the further down in the bed of grit the separation occurs.

In connection with the device, according to the second aspect, for separating mainly organic matter and solid matter from a flowing liquid, perforated screens, belt screens or screening stairs are commonly used. Such devices of the above-mentioned type move solid particles and objects up from flowing water in a duct. Regarding perforated screens, the equipment consists of a number of belt elements which form an endless belt. Each belt element is usually perforated or water-permeable in some other manner. In operation, the solid particles and the objects are fed upwards along the belt to a discharge position where the belt returns downwards. Any water that collects on the belt elements in upwards feeding is drained through their perforations, or the like, back into the duct. The upwardly fed solid particles and objects on the belt are released and fall down from the discharge position to, for example, transport equipment for further transport. To remove the solid particles and the objects from the belt elements and/or the discharge position, there are arranged brushes, supply of water, supply of air, scrapers or other types of rakes for cleaning. Also rotating brushes may be used in the discharge position.

The drawbacks of this type of wastewater treatment plant are one or more of the following:
parts of the solid particles and the objects do not come loose from the belt in the discharge position;
when supplementary cleaning is used, for instance by means of brushes, parts of the solid particles and the objects stick to such scraping equipment, which deteriorates their cleaning power.

In connection with the device, according to the third aspect, for separating mainly organic disintegratable matter from solid matter, such as separating mainly faeces from solid objects and compressing these objects, a screw-type washing press is commonly used.

The screw-type washing press of the above type usually has a washing zone and a pressing zone. The supplied material which usually contains some liquid is moved by means of the rotating screw to the washing zone where washing water is supplied to wash away faeces from solid objects and where the faeces accompany the washing water. The washed solid objects are then moved by the screw to the pressing zone for dewatering and compressing. The solid objects are compressed, and the water is pressed out radially-through a perforated housing. The compressed material is discharged at the end of the screw.

To achieve a more effective washing process, solutions such as a mill or the like are currently used. With this solution however, many solid objects, such as paper and sanitary towels, are disintegrated and undesirably accompany the washing water. The drawbacks of these types of wastewater treatment plants are one or more of the following:
the washing process breaks the solid matter to pieces and disintegrates it;
small particles of disintegrated solid matter accompany the washing water;
the perforated housing is clogged by supplied material, thus reducing the compressing function;
the supplied material forms lumps in the screw;
the discharged material is not sufficiently compressed, washed and/or dry.

An object of the inventive concept is to provide a wastewater treatment device, which for the purpose of eliminating at least one or more of the above-described drawbacks and inconveniences results in improved wastewater treatment.

Another object is to provide a wastewater treatment device which enables an improved separating effect of the parts involved and included.

Yet another object is to provide an improved wastewater treatment device without necessitating major changes in terms of construction. One more object is to provide a cost-effective solution to one or more of the above problems.

### SUMMARY OF THE INVENTION

According to a first aspect of the inventive concept, the object as stated by way of introduction is achieved, in which the container comprises at least one vibrating means arranged inside the container, said vibrating means, while vibrating in cooperation with the supplied separating water, separating said inorganic matter from said organic matter, said inorganic matter being moved towards said outlet, said organic matter with said liquid being moved towards said discharging means.

The invention as defined in claim 1 gives several advantages, such as improving the separation of the mainly organic matter from the mainly inorganic matter and, thus, reducing the amount of organic matter in the inorganic matter.

There is also provided movement of the matter in the container which is close to the vibrating means, whereby the separating water obtains an improved separating effect for the organic and inorganic matter. Furthermore the inside of the container walls can be kept cleaner from accumulated solid matter.

In addition, this is achieved by using a small number of movable parts where the absence of, for example, a blade agitator means that there is no sticking of material to an agitator.

Preferably, the vibrating means is essentially centrally arranged in the container relative to the lateral surfaces of the container. Owing to the position of the vibrating means, the vibration intensity is at its maximum in the centre of the container and decreases radially towards the lateral surfaces of the container.

The vibrating means is advantageously arranged in a tubular element which is arranged in the container.

This allows the vibrating means to be kept essentially free from collected organic or inorganic matter. This also improves the possibility of access for service purposes.

The vibrating means is suitably adapted to be at least partially peripherally surrounded by said inorganic matter and organic matter with liquid to give the desired vibration effect.

The vibrating means can be essentially perpendicularly arranged in a lower part of the container, the vibrating intensity along the vibrating means increasing downwards adjacent to said vibrating means. The position of the vibrating means in a lower part of the container which is surrounded by lateral surfaces as well as a bottom enables improved movement of the matter that is positioned in the container in the vicinity of the vibrating means.

According to a second aspect of the inventive concept, the object as stated by way of introduction is achieved, wherein said unloading portion comprises at least one vibrating means for releasing, by vibration, the entrained mainly organic matter and solid matter from the unloading portion.

The invention as defined in claim 6 gives several advantages, such as improving the removal of entrained material, such as screening material from the collecting and discharging means adjacent to the discharge portion, by the vibration effect.

Said vibrating means is advantageously arranged in a tubular element of the unloading portion. In this manner, the removal of organic matter from the parts of the screening unit adjacent to the unloading portion is improved, without other projecting machine elements that can collect the entrained matter.

The screening unit has at least one belt element which forms an endless belt.

According to a third aspect of the inventive concept, the object as stated by way of introduction is achieved, in which the device has at least one vibrating means for improving the separation of said mainly organic disintegratable matter from said solid matter.

The invention as defined in claim 9 gives several advantages, such as improving the washing of the solid matters and purifying them from mainly organic disintegratable matter. Moreover, the separation of the liquid from the material that is compressed can be improved and allow a reduced amount of liquid in the compressed material. Moreover, the number of movable parts can be kept down by the arrangement of the vibrating means. The screw means is preferably arranged with said vibrating means, which results in a good capacity of transferring vibrations to the surrounding material.

Said screw means has preferably a centrally driven shaft provided with a thread, and said vibrating means is suitably arranged in the shaft of said screw means. This allows good transfer of vibrations to the thread of the screw means and to the perforated housing.

The vibrating means is suitably arranged in the screw means adjacent to said compressing portion, thereby transferring vibrations to the fed material when in compact form and reducing the risk of its sticking to the surrounding perforated housing.

Alternatively, the vibrating means can be arranged adjacent to the receiving portion in order to thus achieve improved separation of the mainly organic disintegratable matter from the solid matter and improve the washing operation.

The object as stated by way of introduction is also achieved by a vibrating means which is arranged in a device as described above. The vibrating means can be a poker vibrator.

This makes it possible to provide a vibration effect so that the wastewater treatment plant obtains its intended function.

### BRIEF DESCRIPTION OF THE DRAWINGS

The invention will now be described with reference to the accompanying drawings, which by way of example illustrate preferred embodiments of the invention.

FIG. 1 is a schematic side view in cross-section of a grit washer according to a first embodiment of the invention.

FIG. 2 illustrates schematically a perforated screen according to a second embodiment of the present invention.

FIG. 3 is a schematic side view in cross-section of a screw-type washing press according to a third embodiment of the present invention.

FIG. 4 is a schematic side view in cross-section of a screw-type washing press according to a fourth embodiment of the present invention.

### DESCRIPTION OF PREFERRED EMBODIMENTS

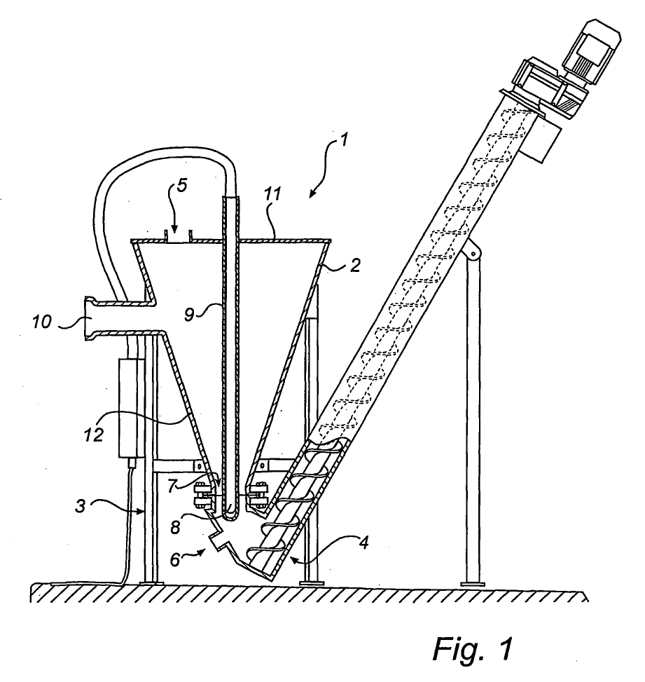

FIG. 1 illustrates a grit washer 1 which comprises a tapered container 2 preferably made of stainless steel. The container 2 is fixed to and suspended from a frame 3 with the tapered part of the container directed downwards. At the bottom of the container discharge equipment 4 is mounted, which in this case is a connected grit screw for removing the washed grit.

The container 2, which preferably has the shape of a truncated cone and is rotationally symmetric about a centre line A, is adapted to hold various materials, such as organic matter, inorganic matter and liquids. The lateral surfaces 12 of the container 2 thus taper downwards. It will be seen in FIG. 1 that the upper part of the container has a first inlet 5 for supplying material to be purified and separated. In this case, the supplied material may comprise grit, gravel, stones, organic substances and various water-like liquids.

The lower part of the container 2 is provided with a second inlet 6 to be able to feed, in an optional and controllable manner, washing water to the lower part of the container. It goes without saying that the lower part of the container can be provided with a plurality of inlets. The bottom of the container 2 has an outlet 7 to be able to remove inorganic matter, which in this case is grit and other such materials of similar density. The discharge equipment 4 is mounted at the second outlet 7 in order to be able to optionally discharge the washed grit from the container 2.

Referring once more to FIG. 1, the container has a vibrating means 8 arranged inside, in its cavity. The vibrating means 8 is in this case mountably arranged in a tubular element 9, such as a metal tube. The element 9 is suitably sealed at its lower end to prevent pollutants from reaching the inside of the element and the vibrating means 8. The element is suitably adjustably arranged, which means that the tube 9 with the vibrating means can be moved, for example, horizontally and vertically. The vibrating means 8 can, for example, also be movably arranged inside the tube 9 to control the position of the vibrating means relative to the container 2 and its contents.

According to the first embodiment, the vibrating means 8 is centrally perpendicularly arranged adjacent to the centre line A. The vibrating means 8, which in this case is a poker vibrator, has its main vibration effect at and around its free end. The free end of the vibrating means 8 is suitably arranged in the lower part of the container 2.

Referring once more to FIG. 1, the container 2 has in the upper part a connectable means 10 for discharging organic matter and liquid from the container. In FIG. 1 this means 10 is an outlet. The discharging means 10 can also consist of a plurality of outlets for separating liquid and organic matter. The discharging means 10 can also be a channel arranged at the top of the container and around the same for receiving excess liquids and substances. The container preferably has a lid 11 which is mountably arranged at the upper end of the container 2. The lid can be provided with one or more inlets and/or outlets.

The function of the grit washer and the vibrating means will be described in the following. When a washing cycle is to be begun, the container 2 has a relatively clean bed of grit from a preceding purifying cycle in the lower part of the container 2. The screening material which mainly comprises grit, organic matter and possibly also liquid is supplied to the container and the bed of grit through the first inlet 5.

Washing water is supplied to the bed of grit through the second inlet 6. The separating water moves preferably from below through the bed of grit and entrains some of the lighter material, such as the organic matter. The vibrating means is in operation preferably in the form of short cycles during this separating process. The vibration effect of the vibrating means thus assists in releasing and separating the organic matter from the inorganic grit. The vibration effect causes in turn a friction effect between the grains of grit or the like, the grit is purified and organic matter is released by the washing water. The temporary water paths which are normally created through a grit-like material when water is supplied are set in motion by the vibrating means. The temporary water paths are broken by vibration or their extent is reduced, thus forcing the water to take different courses through the grit, thus improving the washing of the grit.

When the supplied washing water rises through the bed of grit in the container, the water entrains the organic matter up towards the connectable means 10. Also in this part of the process, the vibrations have a positive effect since they make it difficult for material to collect along the inside of the container 2 and also on the outside of the tubular element 9. The vibration intensity increases from the top and down for two reasons, the first being that the container has a tapered shape, which means that the vibrations can act along a decreasing radius seen from above and down along the centre line A. The second reason is that the free end of the vibrating means is vertically adjusted to be aligned with the lower part of the container, where the free end of the vibrating means has a higher vibration intensity.

The organic matter which essentially swims on the liquid in the container is removed through the outlet 7. The container 2 can have additional outlets for organic matters of different densities. Also, the container can have a plurality of outlets in the upper part of the container.

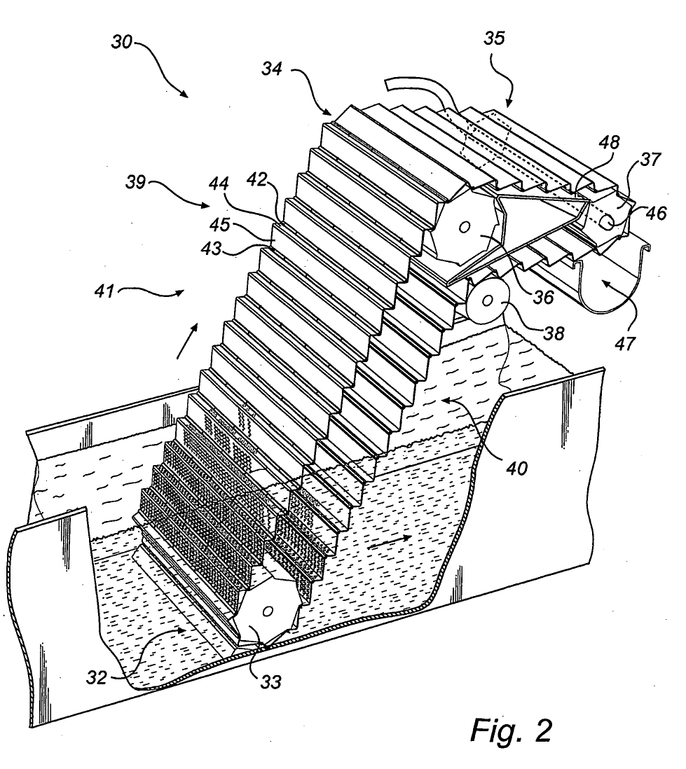

FIG. 2 illustrates an elongate screening unit 30, which in this case is a perforated screen. The main purpose of the screening unit 30 is to collect and remove solid particles and objects from a duct in which preferably water flows. The elongate screening unit 30 suitably has a supporting frame (not shown) so that a lower part 32 of the screening unit can be placed in a liquid-filled duct. The screening unit 30 is in this embodiment adapted to be inclined upwards, rearwards in the direction of flow of the liquid, but can also be arranged quite perpendicularly or, alternatively, transversely to the direction of flow. The lower part 32 has at least one lower belt roll 33 which is rotatably arranged in the frame.

The upper part 34 of the elongate screening unit 30 has an unloading portion 35 for removing the collected solid particles and the objects. The upper part 34 has at least a first upper belt roll 36 which is rotatably arranged in the frame. The upper belt roll is preferably rotatably driven by an electric motor (not shown). The unloading portion 35 has at least one rotatably arranged deflection roll 37. The screening unit 30 has also at least a second upper belt roll 38 which is rotatably arranged in the frame.

Referring once more to FIG. 2, the screening unit 30 has movably arranged collecting and discharging means 39 to form an endless belt 40. The belt 40 runs partially peripherally around the lower belt roll 33, the first upper belt roll 36, the deflection roll 37 and the second upper belt roll 38.

When the elongate screening unit 30 has its lower part 32 placed in the duct, the lower belt roll 33 is preferably arranged below the liquid level in the duct, where the width of the belt 40 with the collecting and discharging means 33 preferably occupies essentially the entire width of the duct.

From the belt roll 33 the belt runs essentially parallel to a feeding portion 41 of the screening unit 30 up to the upper belt roll 36. With reference to FIG. 2, the feeding portion 41 suitably has an upward inclination with the first upper belt roll 36 placed above and down-stream of, relative to the direction of flow of the water, the lower belt roll 33 in the duct.

The belt 40 runs from the first upper belt roll 36 slightly obliquely downwards, downstream relative to the direction of flow of the water, to the deflection roll 37. From the deflection roll 37 the belt 40 turns essentially backwards, upstream relative to the direction of flow of the water, to the second belt roll 38. Finally the belt runs obliquely downwards, slightly upstream relative to the direction of flow of the water, towards the lower belt roll 33.

The belt 40 which is formed by the collecting and discharging means 39 preferably consists of perforated stepped elements. The stepped elements 30 have, seen sideways, preferably a V-shaped wedge shape. The element 39 is preferably made of a bent perforated stainless steel sheet. As is evident from FIG. 2, the front end 42 of the element 39 is, in the feeding direction of the belt, hingedly attached to the preceding element and the rear end 43 of the element 39 to the subsequent element. The front end 42 has a perforated shoulder 44 to form the step where the essentially entrained material is collected during feeding. An elongate perforated step portion 45 connects the shoulder 44 to the rear end 43 of the stepped element 39.

The deflection roll 37 adjacent to the unloading portion 35 is formed preferably from a hollow cylindrical shaft surrounded by a friction material of, for example, rubber, which wholly or partly contacts the entire width of the belt 40.

Inside the cylindrical shaft a vibrating means 46 is mountably attached. The vibrating means is preferably a high-frequency poker vibrator 46 which is releasably attached to the deflection roll 37 and occupies essentially the diametric cavity inside the shaft.

The vibrating means 46 is arranged to be at least partly peripherally surrounded by the screening material adjacent to the unloading portion 35.

A transport device, preferably a belt-fed duct 47, is preferably arranged at a distance under the deflection roll 37 for further transport of the collected solid particles and objects. Of course, for instance a screw-type washing press can be arranged under the deflection roll 37 instead of the duct 47 to receive the collected material.

A drainage sheet 48 is arranged under the belt between the first upper belt roll 36 and the deflection roll 37. The drainage sheet preferably has an adjusted inclination towards the duct 47 so that the screening material that reaches the sheet can flow off to the duct 47.

The function of the perforated screen will be explained in the following.

When screening material, such as particles and objects, approaches the lowered portion of the belt 40 and is taken up from the liquid-filled duct by the rotation of the belt, the taken-up main amount of liquid flows through the perforations of the stepped elements 39. The screening material, which is mainly collected adjacent to the shoulders 44, is fed by the belt up to the first upper belt roll 36. From the upper belt roll 36 to the deflection roll 37, the belt is suitably slightly inclined downwards relative to a horizontal plane. This means that the screening material at this moment mainly rests on the elongate step portions 45.

At the turning point of the belt 40 on the deflection roll 37, the belt turns directly downwards and ceases to support the screening material. The screening material can thus, by the vibration effect and by means of gravity, be released from the collecting and discharging means 39.

Optionally the perforated screen can be supplemented with cleaning by water being supplied to the unloading portion 35 for instance.

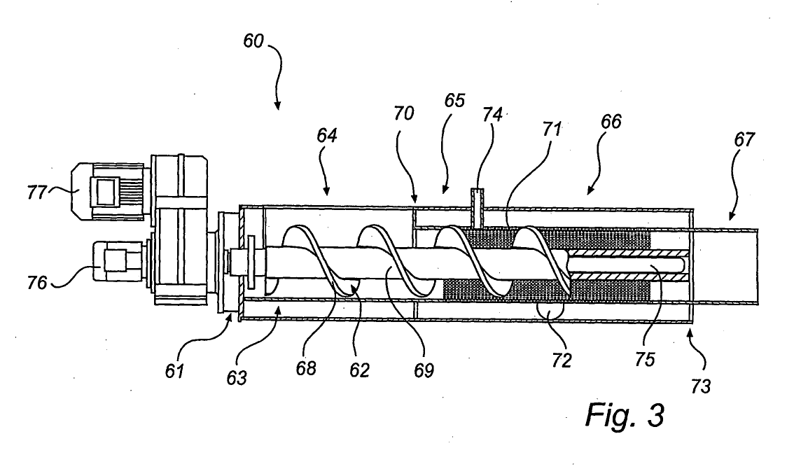

FIG. 3 is a schematic view of a screw-type washing press 60, partly in section and in a side view. The main purpose of the screw-type washing press 60 is to separate mainly organic disintegratable matter from solid matter and washing and compressing the solid matter.

The screw-type washing press 60 has an elongate screw trough 63 which is supported by a body 61. A rotatably arranged screw means 62 is arranged in the body 61 and driven by a motor 77. The screw means 62 has a longitudinal extent which is essentially similar to that of the surrounding screw trough 63. At one end the screw-type washing press has a receiving portion 64 for receiving organic matter containing liquid. The screw-type washing press 60 also has a washing portion 65 which is arranged essentially in the centre of the longitudinal extent of the screw trough 63 for supplying washing water. A compressing portion 66 is also arranged along the longitudinal extent of the screw trough 63 for dewatering and compressing of the screening material. The screw-type washing press 60 has at its other end a discharge portion 67 for removing the compressed material.

The screw means 62 is provided with a thread 68 which is arranged on the outside of a hollow tubular shaft 69.

The receiving portion 64 and the washing portion 65 are partly separated by a partition 70 provided with an opening through which the thread of the screw means diametrically rotates freely. The screw trough 63 is adjacent to the washing portion 65 and the compressing portion 66 provided with an inner cylindrical perforated housing 71 of steel or stainless material. The washing portion 65 has an inlet 74 adjacent to the housing 71 for supply of washing water. On the outside of the perforated housing 71, the screw trough has in its lower part an outlet 72 for liquid. The end of the screw trough 63 adjacent to the compressing portion 66 is provided with a displacement element 73, formed with a passage, to provide a stop for the material that is to be compressed.

A vibrating means 75 is mountably arranged in the shaft 69 essentially adjacent to the compressing portion 66. The vibrating means 75 preferably also gives a vibration effect to the washing portion 65. The vibrating means 75 is thus surrounded peripherally by the screening material in order to obtain the desired result according to the intentions of the invention. The vibrating means 75 also suitably has a drive unit 76 at one end of the screw-type washing press for driving the vibrating means 75. The vibrating means 75 is preferably a poker vibrator, for instance of the type used in concrete casting.

The function of the screw-type washing press and the function of the vibrating means will be described below.

When screening material is fed to the receiving portion, the screw feeds the material further through the partition 70 to the washing portion 65. The screening material, which can be separated by means of a screen, a perforated screen or the like, suitably consists of solid matter and organic disintegratable matter which may comprise some liquid. Examples of solid matter are paper, plastics, sanitary napkins and other sanitary articles which should be separated from the purifying process. Examples of organic disintegratable matters are faeces and other organic substances which are suited to be processed, together with liquid, in a wastewater treatment plant. Washing water is supplied to the material suitably adjacent to the washing portion, and faeces are separated from any solid objects and the solid objects are washed in the washing portion 65. The screw means 62 moves the washed material along the screw trough 63 to the compressing portion 66. The displacement element 73 causes, with the feeding of the screw means 62, the washed material to be compressed, and liquid is pressed out through the perforation passages of the housing 71. The compressed material forces its way through the displacement element 73 and out through the discharge portion 67. The vibrating means 75 results in the screening material being given better separation and washing, and collected material can be released at the perforations of the housing 71. The diametrically central position of the vibrating means further provides a possibility of adjusted vibration intensity for transferring a movement to the screening material in order to prevent accumulation. The vibration effect also means that the separation and washing of the solid matter are improved adjacent to the washing portion 65. The vibration-effect also means that the screening material and the liquid under pressure adjacent to the compressing portion 66 are given improved separation between liquid and solid matter.

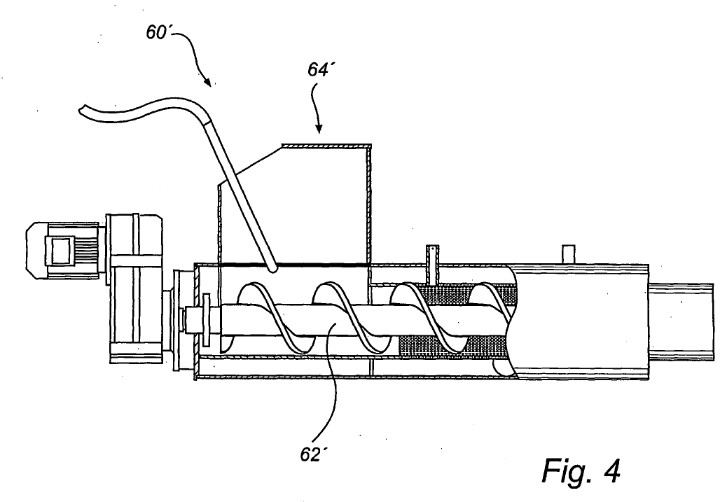

With reference to FIG. 4, a fourth embodiment of the present invention will be described. FIG. 4 shows a screw-type washing press 60′ essentially in accordance with the description above, but a vibrating means 75′ is arranged in the receiving portion 64′ with the free end of the vibrating means directed towards the screw means 62′. The vibrating means 75′ preferably forms an angle to the screw means 62′. The free end of the vibrating means 75′ can thus be surrounded by the received material. In this manner, the received material to be separated and washed can be subjected to vibrations so as to achieve the desired effect as described above. It will be appreciated that the above-described embodiments of the invention can be modified and varied by a person skilled in the art without departing from the inventive idea as defined in the claims.

For instance the vibrating means of the above-described embodiments can be adjusted to give optionally continuous or discontinuous vibrations with an optional intensity during the purifying cycle, thus achieving the object of the invention, comprising separating, releasing or removing as described above.

Moreover vibrations can be effected by other suitable vibrating means which give mechanical vibrations.

It is, of course, also possible to use other vibrating means which generate acoustic vibrations, such as ultrasound.

The embodiments described above consist of suitable materials which are adapted for the field of application according to the intentions of the invention. Examples of construction materials are different types of stainless steel, acid-resistant stainless steel, plastics and composite material.

The first embodiment, the grit washer, can further be adjusted by simple means, the vibrating means being vertically adjustable during the purifying cycle. Furthermore the vibrating means can be arranged in an agitator, which is rotatably arranged in the lower part of the container. The vibrating means may further comprise two or more vibrating means for distributing the vibrations axially and/or peripherally. For example, the vibrating means can be in the shape of a spindle with a plurality of angled vibrating arms. The grit washer may further be provided with a suction apparatus for removing organic matter such as sludge.

It will further be appreciated that the second embodiment of the invention can be modified and varied by a person skilled in the art to relate to screening stairs arranged with a vibrating means adjacent to its corresponding unloading portion. The screening stairs are provided, for instance, with a set of collecting and discharging means in the form of movably arranged screening rods. The screening stairs are also provided with a set of fixedly arranged screening rods in order to perform the upwards feeding of the objects and the solid particles from the liquid using the movable screening rods. Also in this case, the vibrating means causes the upwardly fed material to be released from collecting and discharging means adjacent to the unloading portion in accordance with the description above. The second embodiment may further also be adjusted to concern bucket elevators arranged in the form of an endless chain elevator in a belt loop. Here too, a vibrating means can be arranged adjacent to the unloading portion in the same manner as described above. Correspondingly, also the second embodiment can be applied to a belt screen which is formed of a water-permeable endless belt which can be provided with peripheral projections corresponding to the collecting and discharging means. Further the second embodiment may be varied by the device being placed in an alternative direction instead of the flow direction of the liquid in the duct. For example, the device can be arranged transversely to the flow direction of the liquid.

The third embodiment, the screw-type washing press, can be supplemented with, for instance, yet another vibrating means adjacent to the receiving portion according to the fourth embodiment.

1. A device for separating mainly organic matter from mainly inorganic matter, especially organic pollutants from grit in wastewater treatment plants, said device comprising a container which is adapted to receive organic matter, inorganic matter and liquid, said container having
at least a first inlet for supplying organic and inorganic matter to said container,
at least one outlet arranged adjacent to said container for discharging inorganic matter from said container,
at least a second inlet for supplying separating water, and
at least one connectable means for discharging organic matter and liquid from said container wherein the container comprises
at least one vibrating means arranged inside the container,
said vibrating means, while vibrating in cooperation with the supplied separating water, separating said inorganic matter from said organic matter,
said inorganic matter being moved towards said outlet,
said organic matter with said liquid being moved towards said discharging means.

2. A device as claimed in claim 1, wherein said vibrating means is essentially centrally arranged in the container relative to the lateral surfaces of the container.

3. A device as claimed in claim 1, wherein said vibrating means is arranged in a tubular element which is arranged in the container.

4. A device as claimed in claim 1, wherein the vibrating means is adapted to be at least partially peripherally surrounded by said inorganic matter and organic matter with liquid.

5. A device as claimed in claim 1, wherein the vibrating means is essentially perpendicularly arranged in a lower part of the container, the vibrating intensity along the vibrating means increasing downwards adjacent to said vibrating means.

6. A device for separating mainly organic matter and solid matter from a flowing liquid, especially for collecting and discharging solid particles and objects in flowing liquids in wastewater treatment plants,
the device comprising an elongate screening unit with a lower parts which is arrangeable in a duct with flowing liquid,
the screening unit being adapted to project upwardly from the duct,
said screening unity being provided with at least one set of movably arranged collecting and discharging means,
said collecting and discharging means being operable by a drive unit for moving said mainly organic matter and said solid matter up from said flowing liquid to be fed upwards along said elongate screening unit to an unloading portion, wherein
said unloading portion comprises at least one vibrating means for releasing, by vibration, the entrained mainly organic matter and solid matter from the unloading portion.

7. A device as claimed in claim 6, wherein said vibrating means is arranged in a tubular element of the unloading portion.

8. A device as claimed in claim 6, wherein said screening unit has at least one belt element which forms an endless belt.

9. A device for separating mainly organic disintegratable matter from solid matter, especially separating in wastewater treatment plants mainly faeces from solid objects and compressing said objects, said device having
a screw trough with a rotatably arranged screw means,
a receiving portion for receiving said organic disintegratable matter and said solid matter,
a washing portion with liquid supply for separating said mainly organic disintegratable matter from said solid matter,
a compressing portion for compressing said solid matter, said compressing portion being surrounded at least partially by a perforated housing, and
a discharge portion for compressed matter,
said screw means essentially extending from said receiving portion to said discharge portion,
said screw means feeding said organic disintegratable matter and said solid matter from said receiving portion to said washing portion for supply of liquid and separation, the liquid being pressed by said screw means through said perforated housing adjacent to said compressing portion, the screw means discharging said compressed matter adjacent to the discharge portion, wherein
at least one vibrating means for improving the separation of said mainly organic disintegratable matter from said solid matter.

10. A device as claimed in claim 9, wherein said screw means is arranged with said vibrating means.

11. A device as claimed in claim 9, wherein said screw means has a centrally driven shaft provided with a thread.

12. A device as claimed in claim 11, wherein said vibrating means is arranged in the shaft of said screw means.

13. A device as claimed in claim 9, wherein the vibrating means is arranged in the screw means adjacent to said compressing portion.

14. A device as claimed in claim 9, wherein the vibrating means is arranged adjacent to the receiving portion.

15. A vibrating means arranged in a device as claimed in claim 1.

16. A vibrating means as claimed in claim 15, wherein the vibrating means is a poker vibrator.
